(19) United States
(12) Patent Application Publication
(10) Pub. No.: US 2014/0089263 A1
(43) Pub. Date: Mar. 27, 2014

(54) FILE RECORDING APPARATUS, FILE SYSTEM MANAGEMENT METHOD, AND CHANGER DRIVE

(71) Applicant: Sony Corporation, Tokyo (JP)

(72) Inventor: Takahiro ARAKI, Kanagawa (JP)

(73) Assignee: Sony Corporation, Tokyo (JP)

(21) Appl. No.: 14/033,146

(22) Filed: Sep. 20, 2013

(30) Foreign Application Priority Data
Sep. 27, 2012 (JP) 2012-214779

(51) Int. Cl. G06F 17/30

(52) U.S. Cl. CPC G06F 17/30227
USPC 707/648

(57) ABSTRACT

A file recording apparatus handles a drive as a storage device, and the drive uses, as a removable recording medium, a cartridge on which a non-volatile memory is mounted and in which one of a disk-shaped recording medium and a tape-shaped recording medium is stored. In the file recording apparatus, when a change request is issued, a file system driver records journaling information of a file system recorded in the recording medium in the non-volatile memory.

### CROSS REFERENCE TO RELATED APPLICATIONS

This application claims the benefit of priority under 35 U.S.C. §119 from Japanese Priority Patent Application JP 2012-214779 filed Sep. 27, 2012, the entire contents of each which is incorporated herein by reference.

### BACKGROUND

The present disclosure relates to a file recording apparatus, a file system management method, and a changer drive, and more specifically to a file recording apparatus that handles, as a storage device, a drive that uses a cartridge on which a non-volatile memory is mounted and in which a disk-shaped or tape-shaped recording medium is stored as a removable recording medium, and the like.

In the case where a file is stored in a disk medium such as an HDD (hard disk drive), generally, software called a file system is used. By the file system, files in the disk medium is managed so as to be easily accessible. There are various kinds of file systems, and the file systems each store a file and management information thereof (hereinafter, referred to as “file system (FS) metadata” in a disk medium.

The FS metadata includes information such as a table that indicates a storage position of main body data of a file in a disk medium and a capacity thereof, for example. In order to cause the file system to normally operate, it is necessary to maintain consistency of information in the FS metadata. This is because inconsistency in the FS metadata affects entire accesses to the disk, and even slight damage is fatal thereto. For example, when writing is being performed in a disk medium, power of an apparatus is turned off, which may bring the FS metadata in the disk medium into a state of inconsistency.

This problem has been overcome to some extent by a technique called journaling. In the journaling, at the time when the FS metadata is changed, information relating to a changed part (difference), that is, journaling information is stored in a region different from a region where main body data is stored. The journaling information is used to restructure the FS metadata after an update from the FS metadata before the update.

In the case where the power of an apparatus is turned off during writing in a disk medium, there may be no correct information in the FS metadata region in the disk medium. On the basis of the journaling information stored in the different region, the FS metadata restructured is written in the FS metadata region in the disk medium, thereby making it possible to maintain the consistency of the entire FS metadata.

For example, Japanese Patent Application Laid-open No. 2005-115857 (hereinafter, referred to as Patent Document 1) discloses that journaling information is recorded in a non-volatile memory such as an NVRAM, and then FS data of an HDD is updated, thereby recovering a file system by using the journaling information recorded in the non-volatile memory, at the time when a trouble such as power failure is caused.

### SUMMARY

However, in the technique disclosed in Patent Document 1, the non-volatile memory such as the NVRAM is mounted on a file recording apparatus such as a PC (personal computer) itself. Therefore, there is an inconvenience in that only the file recording apparatus in which the trouble such as the power failure is caused can recover the file system. Further, in the technique disclosed in Patent Document 1, the journaling information is recorded in the non-volatile memory, and then the FS data in the HDD is updated so as to correspond to all changes for the FS metadata. If the non-volatile memory is damaged, a created file is not remained in an optical disk, which is inconvenient.

In view of the above-mentioned circumstances, it is desirable to make it possible to recover a file system in a recording medium also by an apparatus other than the file recording apparatus or the like in which the trouble such as the power failure is caused.

According to an embodiment of the present disclosure, there is provided a file recording apparatus that handles a drive as a storage device, the drive using, as a removable recording medium, a cartridge on which a non-volatile memory is mounted and in which one of a disk-shaped recording medium and a tape-shaped recording medium is stored. In the file recording apparatus, when a change request is issued, a file system driver records journaling information of a file system recorded in the recording medium in the non-volatile memory.

In the present disclosure, the drive that uses, as the removable recording medium, the cartridge in which one of the disk-shaped recording medium and the tape-shaped recording medium is stored is treated as the storage device. On the cartridge, the non-volatile memory is mounted. When the change request is issued, a file system driver records journaling information of a file system recorded in the recording medium in the non-volatile memory.

As described above, in the present disclosure, in the non-volatile memory mounted on the cartridge, the journaling information of the file system is recorded. Therefore, it is possible to recover the file system in the recording medium by an apparatus other than a file recording apparatus in which a trouble such as power failure is caused.

Further, in the embodiment of the present disclosure, for example, when the change request is a request that changing and recording are completed only by changing file system metadata, the file system driver may record change information of the file system metadata as the journaling information in the non-volatile memory, instead of changing the file system metadata of the recording medium. In this case, when a new file is created, changing and recording of the file system metadata is performed in the recording medium. Even in the case where the non-volatile memory is damaged before the journaling information recorded is reflected on the file system in the recording medium, it is possible to cause the created file to remain in the recording medium.

In addition, in the present disclosure, for example, when a new file is created in the recording medium, the file system driver may perform changing and recording of file system metadata on which the journaling information recorded in the non-volatile memory is reflected in the recording medium and delete the journaling information from the non-volatile memory.

Further, in the present disclosure, for example, when mounting is released, the file system driver may perform changing and recording of the file system metadata on which the journaling information recorded in the non-volatile memory is reflected in the recording medium and delete the journaling information from the non-volatile memory.

Further, in the present disclosure, for example, when recording change information of file system metadata in the non-volatile memory, in the case where a recording space for the journaling information in the non-volatile memory is full, the file system driver may perform changing and recording of the file system metadata on which the journaling information recorded in the non-volatile memory is reflected in the recording medium and delete the journaling information from the non-volatile memory.

According to another embodiment of the present disclosure, there is provided a file recording apparatus that handles a drive as a storage device. The drive uses, as a removable recording medium, a cartridge on which a non-volatile memory is mounted and in which one of a disk-shaped recording medium and a tape-shaped recording medium is stored. In the file recording apparatus, the cartridge includes the non-volatile memory for recording journaling information of a file system recorded in the recording medium. When mounting, on the basis of file system metadata recorded in the recording medium and the journaling information recorded in the non-volatile memory, a file system driver structures a file system database and performs changing and recording of the file system metadata on which the journaling information recorded in the non-volatile memory is reflected in the recording medium.

In present disclosure, the drive that uses, as a removable recording medium, the cartridge in which one of the disk-shaped recording medium and the tape-shaped recording medium is stored is handled as the storage device. The cartridge includes the non-volatile memory for recording journaling information of the file system recorded in the recording medium.

When mounting, on the basis of file system metadata recorded in the recording medium and the journaling information recorded in the non-volatile memory, a file system database is structured. Then, the file system metadata on which the journaling information recorded in the non-volatile memory is reflected is changed and recorded in the recording medium.

As described above, in the present disclosure, when mounting, the changing and recording of the file system metadata on which the journaling information recorded in the non-volatile memory mounted on the cartridge is reflected is performed in the recording medium. Therefore, it is possible to recover the file system in the recording medium by an apparatus other than the file recording apparatus in which a trouble such as power failure is caused.

According to the embodiments of the present disclosure, it is possible to recover the file system in the recording medium also by an apparatus other than the file recording apparatus in which the trouble such as the power failure is caused. In addition, according to the embodiments of the present disclosure, it is possible to cause a created file to remain in the recording medium, even if the non-volatile memory in which the journaling information of the file system is recorded is damaged.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram showing a structural example of a file recording embodiment as an embodiment;

FIG. 2 is a flowchart showing an example of a process in response to a change request during mounting in a file system driver;

FIG. 3 is a diagram showing an outline of a recording process for an optical disk when new creation of a file is requested;

FIG. 4 is a state of FS metadata information reflection;

FIG. 5 is a diagram showing an example of journaling information to be recorded in a cartridge memory (CM); and

FIG. 6 is a flowchart showing an example of FS metadata information reading at the time of mounting and a process of journaling information reflection in the file system driver.

### DETAILED DESCRIPTION OF EMBODIMENTS

Hereinafter, an embodiment of the present disclosure will be described with reference to the drawings. It should be noted that the description will be given in the following order.

1. Embodiment

2. Modified example

### 1. Embodiment

(Structural Example of File Recording Apparatus)

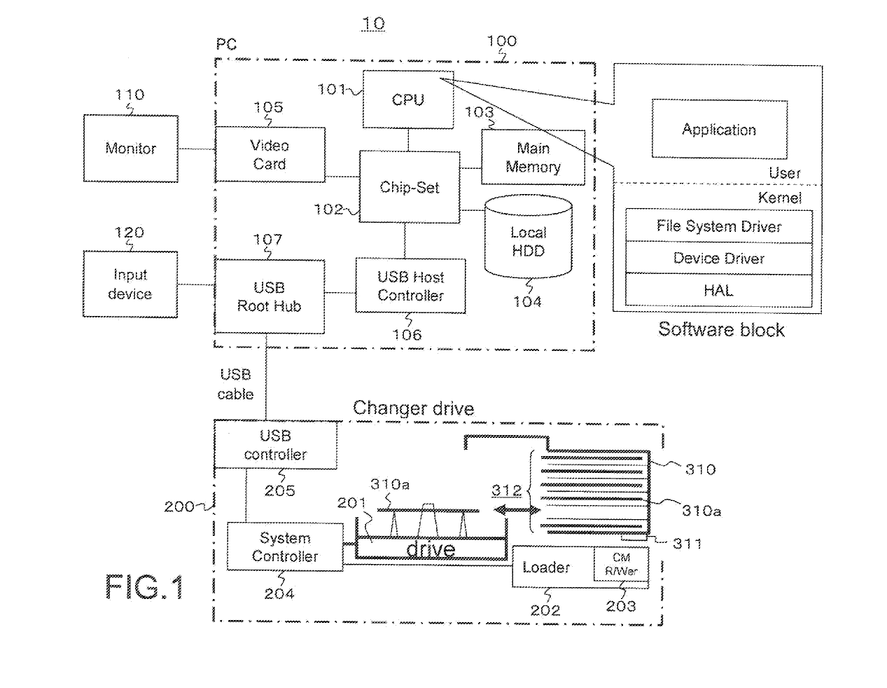

FIG. 1 is a diagram showing a structural example of a file recording apparatus 10 as an embodiment. The file recording apparatus 10 has a structure in which a changer drive 200 is connected to a personal computer (PC) 100 via a USB cable. The PC 100 handles the changer drive 200 as a storage device.

The PC 100 includes a CPU 101, a chip-set 102, a main memory 103, a local HDD 104, a video card 105, a USB host controller 106, and a USB root hub 107. As user interfaces, a monitor 110 and an input device 120 such as a mouse and a keyboard are connected to the PC 100.

In the CPU 101, as software operated on the CPU 101, a file system driver, a device driver, an HAL (hardware abstraction layer), and the like are provided in addition to various applications. The HAL provides a physical I/O of a device, as a standardized interface. The device driver provides a standardized interface to the changer drive connected through a USB. The file system driver provides a standardized file system interface such as a directory structure and a file.

The changer drive 200 includes an optical disk drive 201, a loader 202, a cartridge memory (CM) reader and writer (R/Wer) 203, a system controller 204, and a USB controller 205. The changer drive 200 uses a cartridge 310 in which a predetermined number of optical disks 310a are stored as a removable recording medium. On the cartridge 310, a cartridge memory (CM) 311 which is capable of performing proximity communication and has a non-volatile memory therein is mounted.

The changer drive 200 is controlled by a USB command from the PC 100 as a USB mass storage class. On the basis of the command, from the PC 100, the loader 202 loads the optical disk 310a of any slot 312 in the cartridge 310 into the optical disk drive 201 or unloads (ejects) the optical disk 310a to store the disk in an original slot 312 of the cartridge 310.

The optical disk drive 201 forms a recording medium recording and reproduction unit. The optical disk drive 201 performs recording and reproduction for the optical disk 310a loaded. The CM reader and writer 203 performs recording and reproduction for the cartridge memory 311 by the proximity communication. The CM reader and writer 203 forms a memory recording and reproduction unit.

The file system driver sequentially receives the following change requests during mounting. That is, the file system driver receives the requests of “file creation”, “deletion”, “name change”, “movement”, and “attribute change”. In addition, the file system driver receives the request of “change of a volume label”. Further, the file system driver receives the request of “mount release” along with medium ejection, system shutdown, safe removal of a device, a decrease of power voltage of a PC, or the like.

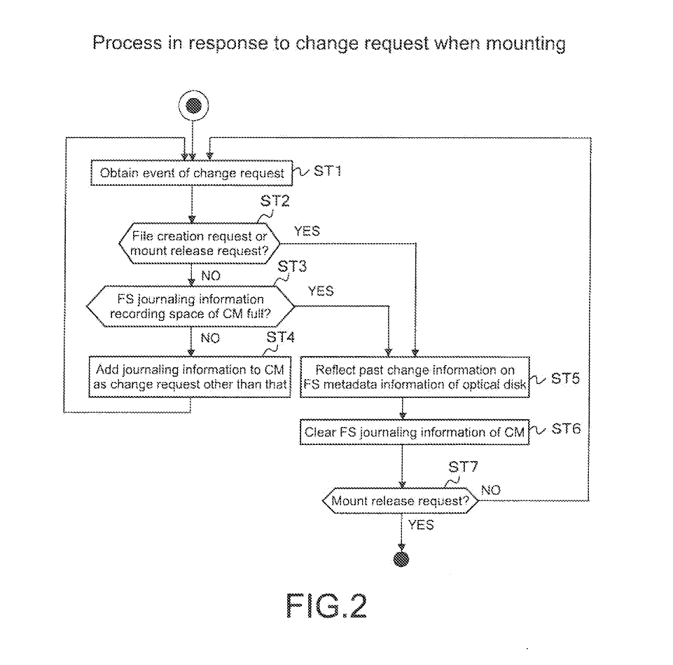

FIG. 2 is a flowchart showing an example of a process in response to a change requests during mounting in a file system driver. In Step ST1, upon obtaining an event of a change request, the file system driver then performs a process of Step ST2. In Step ST2, the file system driver determines whether the request is a file creation request or a mount release request.

If the request is not the file creation request or the mount release request, in other words, if the request is a request of “deletion”, “name change”, “movement”, “attribute change”, “change of a volume label”, or the like, the file system driver then performs a process of Step ST3. For those requests, only by changing file system metadata (FS metadata) in the optical disk 310a, changing and recording are carried out.

In Step ST3, the file system driver determines whether a recording space for journaling information of a file system of the cartridge memory 311 is in a full state or not, in other words, whether there is no vacant space, and it may be impossible to register a new file system journal entry (FS journal entry) or not.

In the recording space is not in the full state, the file system driver adds an FS journal entry relating to the change request in the cartridge memory 311 in Step ST4. At this time, the file system driver holds a change flag with respect to a node on a file system database (FSDB) held in the main memory 103. After that, the file system driver returns to the process of Step ST1.

In the case where the request is the file creation request or the mount release request in Step ST2 or in the case where the recording space is full in Step ST3, the file system driver then performs a process of Step ST5. In Step ST5, the changed information is reflected on the FS metadata of the optical disk 310a. That is, the file system driver performs changing and recording of the FS metadata on which the journaling information recorded in the cartridge memory 311 is reflected in the optical disk 310a. At this time, the file system driver clears the change flag with respect to the node on the file system database (FSDB) held in the main memory 103.

Subsequently, in Step ST6, the file system driver clears (deletes) the journaling information recorded in the cartridge memory 311. Then, in Step ST7, the file system driver determines whether the request is the mount release request or not. If the request is not the mount release request, in other words, if the request is the file creation request, the process returns to Step ST1. On the other hand, the request is the mount release request, the process is terminated. In the case where the request is the mount release request, the file system driver releases the mounting and discards all requests to be executed thereafter.

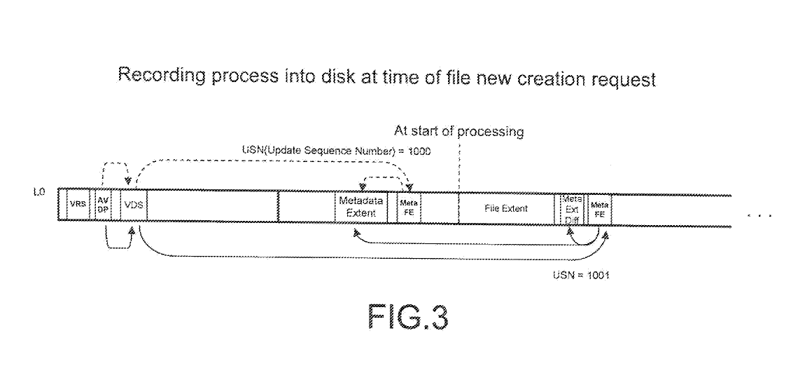

FIG. 3 is a diagram showing an outline of a recording process in an optical disk when new creation of a file is requested. A “Metadata Extent” is a region in which file directory information is stored. A “Metadata FE” is region information (address and size) of the “Metadata Extent”. A “VDS” is region information (address and size) of the “Metadata FE”. An “AVDP” is pointer information (address and size) to the “VDS”. It should be noted that in this example, “UDF2.50” is based, and other “AVDP”, “RVDS”, “Metadata Mirror FE” redundantly recorded are omitted in the figure for convenience of explanation.

Broken-line arrows indicate region information for which UDF (universal disk format) descriptors each perform indication with a pointer before a process is started (USN=1000). In addition, solid-line arrows indicate region information for which UDF descriptors each perform indication with a pointer after the file system driver reflects changed information on FS metadata information of the optical disk 310a during mounting in Step ST5 in a process in response to a change request (see, FIG. 2). In this case, the “VDS” is overwritten by new information.

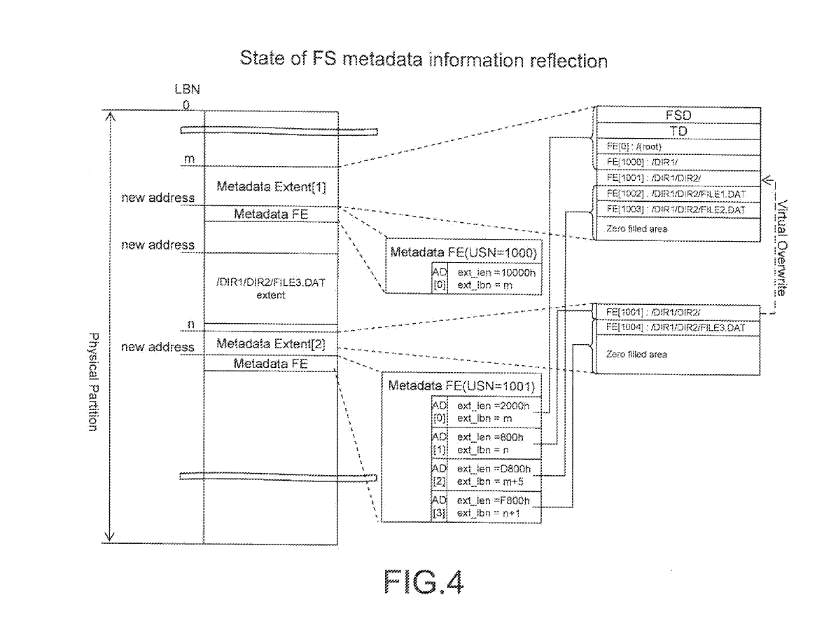

FIG. 4 is a diagram showing a state of reflection of the FS metadata information. Here, by new creation of a file, the file system is updated from “USN=1000” to “USN=1001”.

In “Metadata Extent[1]”, the following information is recorded.

/(root)

LDIR1/

LDIR2/

LFILE1.DAT
LFILE2.DAT

It should be noted that in an actual UDF, a pointer from an FE of a parent directory to FID information is held, and as the FID information, a pointer to a child file directory and name, information are stored, but the FID is omitted in the figure. Further, FE[1000] represents an FE of “FUID (File Unique ID)=1000”. An equivalence of the “File Unique ID” is recorded in a “Unique ID” in the FE.

In the example shown in the figure, as file new creation, “/DIR1/DIR2/FILE3.DAT” is added. In “Metadata Extent[2]”, an FS (including FID information) of “/DIR1/DIR2/” directory changed and the FE of “/DIR1/DIR2/FILE3.DAT” file are recorded. The region information of the “Metadata FE” is rewritten, thereby overwriting the FE of “/D1R1/DIR2/” recorded in the “Metadata Extent[1]” and adding “/DIR1/DIR2/FILE3.DAT”. In addition, a USN, which is an update identification number of the file system (FS) is recorded in the “Metadata FE” (check point information).

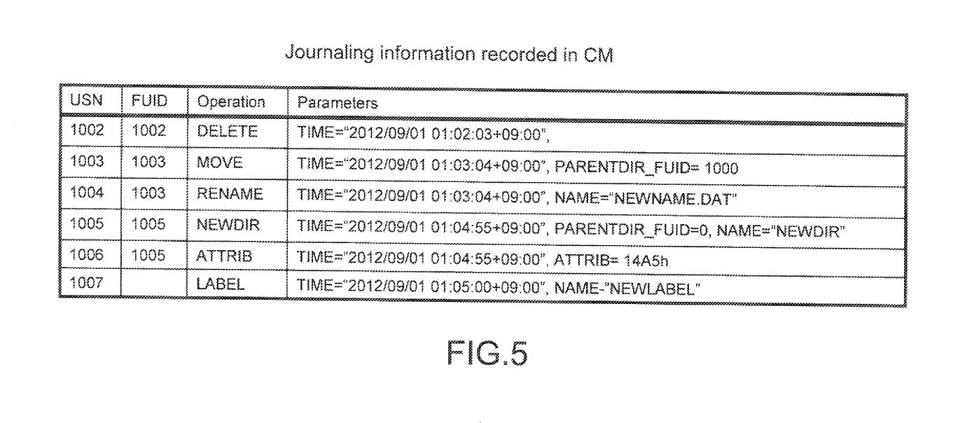

FIG. 5 is a diagram showing an example of the journaling information recorded in the cartridge memory (CM) 311. In this example, the file system driver obtains USN=1003 to USN=1008 as change requests of USN=1002 and the following, and information thereof is recorded in the cartridge memory (CM) 311 as the journaling information.

<USN=1003> is a request for deleting “FE[1002]/DIR1/DIR2/FILE1.DAT”. <USN=1004> is a request for moving “FE[1003]/DIR1/DIR2/FILE2.DAT” to “FE[1000]/DIR1/” and the following. <USN=1005> is a request for changing a name from “FE[1003]/DIR1/FILE2.DAT” to “/DIR.1/NEWNAME.DAT”. <USN=1006> is a request for newly creating a directory of “FE[1005]/NEWDIR/”. <USN=1007> is a request for performing an attribute change of “Permission” of “FE[1005]/NEWDIR/” to “14A5h”. <USN=1008> is a request for changing a volume label to “NEWLABEL”.

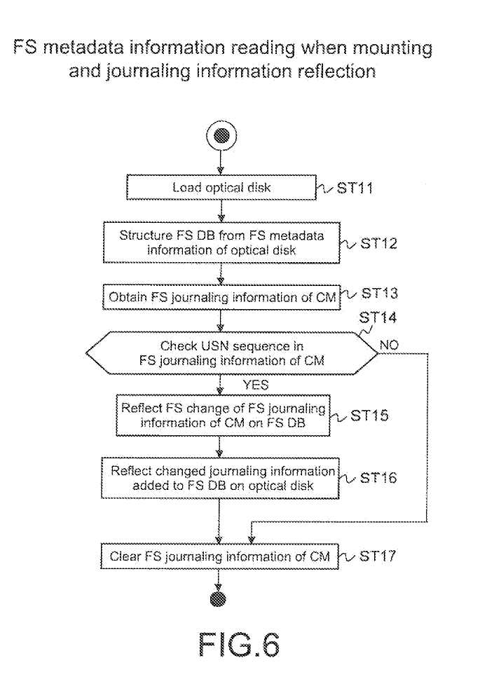

FIG. 6 is a flowchart showing an example of a process of reading FS metadata information during mounting and reflecting the journaling information in the file system driver. The file system driver structures a file system database (FSDB) from the file system information recorded in the optical disk 310a and the cartridge memory 311 in accordance with the flowchart.

In Step ST11, the file system driver loads the optical disk 310a into the optical disk drive 201. Then, in Step ST12, the file system driver structures the internal file system database (FSDB) from the FS metadata information recorded in the optical disk 310a. In this case, the file system driver obtains the FS metadata information from the “Metadata Extent” in order of “AVDP”, “VBS”, “Metadata FE”, and “Metadata Extent” (see, FIG. 3). Further, at this time, the file system driver stores the USN recorded in the “Metadata Extent”.

Subsequently, in Step ST13, the file system driver obtains FS journaling information, from the cartridge memory 311. Then, in Step ST14, the file system driver checks whether a USN sequence in the FS journaling information in the cartridge memory 311 is a USN sequentially numbered from the FS metadata file entry (FS Metadata FE) of the optical disk 310a.

When the sequential numbering is performed, in Step ST15, the file system driver reflects ail the file system changes of the FS journaling information in the cartridge memory 311 on the file system database (FSDB). Here, the reflection method is the same as the process in response to the change request during mounting, and the JS journaling information of the cartridge memory 311 is not changed.

Subsequently, in Step ST16, the file system driver changes and records the FS metadata on which the journaling information added to the file system database (FSDB) is reflected in the optical disk 310a. Then, in Step ST17, the file system driver clears (deletes) the journaling information of the cartridge memory 311 and then terminates the process. It should be noted that, when the sequential numbering is not performed in Step ST14, the file system driver immediately shifts to the process of Step S17 and clears (deletes) the journaling information of the cartridge memory 311 and terminates the process.

As described above, in the file recording apparatus 10 shown in FIG. 1, during mounting, the journaling information of the file system is recorded in the cartridge memory 311 mounted on the cartridge 310. Therefore, in the case where a trouble such as power failure is caused, it is possible to recover the file system in the optical disk 310a on the basis of the journaling information recorded in the cartridge memory 311. In this case, the journaling information is recorded in the cartridge memory 311 mounted on the cartridge 310, so it is possible to recover the file system in the optical disk 310a by an apparatus other than the file recording apparatus 10 in which the trouble such as the power failure is caused.

In addition, in the file recording apparatus 10 shown in FIG. 1, in the case where the change request is such a request that changing and recording operation is completed only by changing the FS metadata, instead of changing the FS metadata of the optical disk 310a, the change information of the FS metadata is recorded as the journaling information in the cartridge memory 311. To write back the FS change at times other than the file creation into the optical disk may cause concern about delay (approximately several hundred msec) or capacity consumption of the optical disk in a recordable medium. However, by writing back the change in the cartridge memory 311, the delay is suppressed (several msec to tens of msec), and the capacity consumption of the optical disk 310a can be suppressed.

In this case, at the time of the new file creation, the changing and recording operation of the FS metadata is performed in the optical disk 310a. Even in the case where the cartridge memory 311 is damaged due for some reasons before the journaling information of the FS recorded in the cartridge memory 311 is reflected on the FS metadata of the optical disk 310a, the created file can be remained in the optical disk 310a.

### 2. Modified Example

It should be noted that in the above embodiment, the changer drive 200 having the cartridge 310 that stores the plurality of optical disks 310a therein as the storage medium is described. However, the cartridge 310 does not necessarily store the plurality of optical disks 310a therein. Further, in the above embodiment, the file recording apparatus 10 configured by connecting the PC 100 with the changer drive 200 with the USB cable is described. The structure in which the changer drive 200 is integrally disposed in the PC 100 is also conceived, for example.

Further, in the above embodiment, the changer drive 200 uses, as the removable recording medium, the cartridge 310 in which the disk-shaped recording media (optical disks) are stored. However, even in the case where the changer drive 200 uses a cartridge in which tape-shaped recording media are stored, it is of course possible to apply the present technology thereto.

It should be noted that the present disclosure can take the following configurations.

(1) A file recording apparatus that handles a drive as a storage device, the drive using, as a removable recording medium, a cartridge on which a non-volatile memory is mounted and in which one of a disk-shaped recording medium and a tape-shaped recording medium is stored, in which

when a change request is issued, a file system driver records journaling information of a file system recorded in the recording medium in the non-volatile memory.

(2) The file recording apparatus according to Item (1), in which

when the change request is a request that changing and recording are completed only by changing file system metadata, the file system driver records change information of the file system metadata as the journaling information in the non-volatile memory, instead of changing the file system metadata of the recording medium,

(3) The file recording apparatus according to Item (1) or (2), in which

when a new file is created in the recording medium, the file system driver performs changing and recording of file system metadata on which the journaling information recorded in the non-volatile memory is reflected in the recording medium and deletes the journaling information from the non-volatile memory.

(4) The file recording apparatus according to any one of Items (1) to (3), in which

when mounting is released, the file system driver performs changing and recording of file system metadata on which the journaling information recorded in the non-volatile memory is reflected in the recording medium and deletes the journaling information from the non-volatile memory.

(5) The file recording apparatus according to any one of Items (1) to (4), in which

when recording change information of file system metadata in the non-volatile memory, in the case where a recording space for the journaling information in the non-volatile memory is full, the file system driver performs changing and recording of the file system metadata on which the journaling information recorded in the non-volatile memory is reflected in the recording medium and deletes the journaling information from the non-volatile memory.

(6) A file system management method in a file recording apparatus that handles a drive as a storage device, the drive using, as a removable recording medium, a cartridge on which a non-volatile memory is mounted and in which one of a disk-shaped recording medium and a tape-shaped recording medium is stored, the file system management, method including

recording, when a change request is issued, journaling information of a file system recorded in the recording medium in the non-volatile memory.

(7) A file recording apparatus that handles a drive as a storage device, the drive using, as a removable recording medium, a cartridge on which a non-volatile memory is mounted and in which one of a disk-shaped recording medium and a tape-shaped recording medium is stored, in which

the cartridge includes the non-volatile memory for recording journaling information of a file system recorded in the recording medium, and

when mounting, on the basis of file system metadata recorded in the recording medium and the journaling information recorded in the non-volatile memory, a file system driver structures a file system, database and performs changing and recording of the file system metadata on which the journaling information recorded in the non-volatile memory is reflected in the recording medium.

(8) The file recording apparatus according to Item (7), in which

when mounting, if a change request is issued, the file system driver records the journaling information of the file system recorded in the recording medium in the non-volatile memory.

(9) A file system management method of a file recording apparatus that handles a drive as a storage device, the drive using, as a removable recording medium, a cartridge on which a non-volatile memory is mounted and in which one of a disk-shaped recording medium and a tape-shaped recording medium is stored, in which

the cartridge includes the non-volatile memory for recording journaling information of a file system recorded in the recording medium, and

when mounting, on the basis of file system metadata recorded in the recording medium and the journaling information recorded in the non-volatile memory, a file system database is structured, and the journaling information recorded in the non-volatile memory is reflected in the recording medium.

(10) A file recording apparatus, including:

a changer drive configured to use, as a removable recording medium, a cartridge on which a non-volatile memory is mounted and in which one of a disk-shaped recording medium and a tape-shaped recording medium is stored; and

a computer configured to handle the changer drive as a storage device, in which

the computer includes a file system driver that records journaling information, of a file system recorded in the recording medium in the non-volatile memory, when a change request is issued.

(11) The file recording apparatus according to Item (10), in which

when the change request is a request that changing and recording are completed only by changing file system metadata, the file system driver records change information of the file system metadata as the journaling information in the non-volatile memory, instead of changing the file system metadata of the recording medium.

(12) A changer drive, including:

a recording medium recording and reproduction unit configured to load, into a drive, a recording medium from a cartridge on which a non-volatile memory is mounted and in which one of a disk-shaped recording medium and a tape-shaped recording medium is stored and perform recording and reproduction with respect to the recording medium;

a memory recording and reproduction unit configured to perform recording and reproduction with respect, to the non-volatile memory, the memory recording and reproduction unit recording and reproducing journaling information of a file system recorded in the recording medium in the non-volatile memory; and

a control unit configured to control the recording and reproduction with respect to the recording medium and the recording and reproduction with respect to the memory.

It should be understood by those skilled in the art that various modifications, combinations, sub-combinations and alterations may occur depending on design requirements and other factors insofar as they are within the scope of the appended claims or the equivalents thereof.

What is claimed is:

1. A file recording apparatus that handles a drive as a storage device, the drive using, as a removable recording medium, a cartridge on which a non-volatile memory is mounted and in which one of a disk-shaped recording medium and a tape-shaped recording medium is stored, wherein
when a change request is issued, a file system driver records journaling information of a file system recorded in the recording medium in the non-volatile memory.

2. The file recording apparatus according to claim 1, wherein
when the change request is a request that changing and recording are completed only by changing file system metadata, the file system driver records change information of the file system metadata as the journaling information in the non-volatile memory, instead of changing the file system metadata of the recording medium.

3. The file recording apparatus according to claim 1, wherein
when a new file is created in the recording medium, the file system driver performs changing and recording of file system metadata on which the journaling information recorded in the non-volatile memory is reflected in the recording medium and deletes the journaling information from the non-volatile memory.

4. The file recording apparatus according to claim 1, wherein
when mounting is released, the file system driver performs changing and recording of file system metadata on which the journaling information recorded in the non-volatile memory is reflected in the recording medium and deletes the journaling information from the non-volatile memory.

5. The file recording apparatus according to claim 1, wherein
when recording change information of file system metadata in the non-volatile memory, in the case where a recording space for the journaling information in the non-volatile memory is full, the file system driver performs changing and recording of the file system metadata on which the journaling information recorded in the non-volatile memory is reflected in the recording medium and deletes the journaling information from the non-volatile memory.

6. A file system management method in a file recording apparatus that handles a drive as a storage device, the drive using, as a removable recording medium, a cartridge on which a non-volatile memory is mounted and in which one of a disk-shaped recording medium and a tape-shaped recording medium is stored, the file system management method comprising
recording, when a change request is issued, journaling information of a file system recorded in the recording medium in the non-volatile memory.

7. A file recording apparatus that handles a drive as a storage device, the drive using, as a removable recording medium, a cartridge on which a non-volatile memory is mounted and in which one of a disk-shaped recording medium and a tape-shaped recording medium is stored, wherein
the cartridge includes the non-volatile memory for recording journaling information of a file system recorded in the recording medium, and
when mounting, on the basis of file system metadata recorded in the recording medium and the journaling information recorded in the non-volatile memory, a file system driver structures a file system database and performs changing and recording of the file system metadata on which the journaling information recorded in the non-volatile memory is reflected in the recording medium.

8. The file recording apparatus according to claim 7, wherein
when mounting, if a change request is issued, the file system driver records the journaling information of the file system recorded in the recording medium in the non-volatile memory.

9. A file system management method of a file recording apparatus that handles a drive as a storage device, the drive using, as a removable recording medium, a cartridge on which a non-volatile memory is mounted and in which one of a disk-shaped recording medium and a tape-shaped recording medium is stored, wherein
the cartridge includes the non-volatile memory for recording journaling information of a file system recorded in the recording medium, and
when mounting, on the basis of file system metadata recorded in the recording medium and the journaling information recorded in the non-volatile memory, a file system database is structured, and the journaling information recorded in the non-volatile memory is reflected in the recording medium.

10. A file recording apparatus, comprising:
a changer drive configured to use, as a removable recording medium, a cartridge on which a non-volatile memory is mounted and in which one of a disk-shaped recording medium and a tape-shaped recording medium is stored; and
a computer configured to handle the changer drive as a storage device, wherein
the computer includes a file system driver that records journaling information of a file system recorded in the recording medium in the non-volatile memory, when a change request is issued.

11. The file recording apparatus according to claim 10, wherein
when the change request is a request that changing and recording are completed only by changing file system metadata, the file system driver records change information of the file system metadata as the journaling information in the non-volatile memory, instead of changing the file system metadata of the recording medium.

12. A changer drive, comprising:
a recording medium recording and reproduction unit configured to load, into a drive, a recording medium from a cartridge on which a non-volatile memory is mounted and in which one of a disk-shaped recording medium and a tape-shaped recording medium is stored and perform recording and reproduction with respect to the recording medium;
a memory recording and reproduction unit configured to perform recording and reproduction with respect to the non-volatile memory, the memory recording and reproduction unit recording and reproducing journaling information of a file system recorded in the recording medium in the non-volatile memory; and
a control unit configured to control the recording and reproduction with respect to the recording medium and the recording and reproduction with respect to the memory.
